(19) United States
(12) Patent Application Publication
(10) Pub. No.: US 2013/0214896 A1
(43) Pub. Date: Aug. 22, 2013

(54) Circuit breaker for a power cable

(71) Applicants: Marko Josifovic, Monchengladbach (DE); Dominik Nentwig, Monchengladbach (DE); Ralf Bodem, Meerbusch (DE)

(72) Inventors: Marko Josifovic, Monchengladbach (DE); Dominik Nentwig, Monchengladbach (DE); Ralf Bodem, Meerbusch (DE)

(73) Assignee: AUTO KABEL MANAGEMENTGESELLSCHAFT MBH, Hausen i.W. (DE)

(21) Appl. No.: 13/640,351

(22) PCT Filed: Apr. 6, 2011
(86) PCT No.: PCT/EP11/55335

§ 371 Date: Nov. 8, 2012

(30) Foreign Application Priority Data
Apr. 15, 2010 (DE) 102010015239.0-34

(51) Int. Cl. H01H 39/00

(52) U.S. Cl. CPC H01H 39/002
USPC 337/416

(57) ABSTRACT

Circuit breaker for a power cable, in particular a battery cable of a motor vehicle, having a first terminal 4, a second terminal 6 electrically connected to the first terminal 4 and having a disconnecting element 14 for mechanically and electrically disconnecting the electrical connection between the terminals 4, 6, wherein the disconnecting element 14 has an auxiliary drive and the auxiliary drive drives the disconnecting element 14 in the event of a trigger to disconnect the electrical connection between the terminals 4, 6. A particularly cost-effective and simple variant of a circuit breaker can be accomplished by the auxiliary drive being formed from a cartridge (16).

The subject matter relates to a circuit breaker for a power cable, in particular a battery cable of a motor vehicle, having a first terminal, a second terminal electrically connected to the first terminal and having a disconnecting element for electrically disconnecting the electrical connection between the terminals, wherein the disconnecting element has an auxiliary drive and the auxiliary drive mechanically drives the disconnecting element in the event of a trigger to disconnect the electrical connection between the terminals.

Circuit breakers for electric cables, in particular for battery cables of motor vehicles, are sufficiently well known. A circuit breaker is therefore known, for example, from DE 10 2004 012 304 A1, in which a current path can be interrupted by a contact element. In the solution described herein, the contact element is driven by a pyrotechnic auxiliary drive. Here, the pyrotechnic auxiliary drive is formed by a primer which is triggered by an electric impulse. The contact element, in this case a piston, is moved in such a way that an electrical connection between the terminals is disconnected. In this respect, the contact element in this publication can also be understood as a disconnecting element according to the subject matter.

A circuit breaker for battery cables is also known from DE 696 04 870 T2. With this circuit breaker, a terminal clamp, which is integral or connected to a battery terminal, is proposed, into which a piston is inserted. A casing is provided in the terminal clamp for this purpose. The piston is firmly attached to an electric supply cable for the power supply. An electrical contact between the terminal clamp and the supply cable can be established and disconnected by moving the piston in the bore. The piston can also, in this case, be understood as a disconnecting element. According to this solution, the piston is also driven by means of a pyrotechnic auxiliary drive. A primer, which is electrically ignited, is also employed in this case.

A circuit breaker for battery cables is also known from DE 196 06 447 A1. With this circuit breaker too, a piston is guided in a sliding manner in a casing and driven by an auxiliary drive. Here too, the auxiliary drive is again a pyrotechnic primer.

The use of pyrotechnic primers is, in many respects, disadvantageous. On the one hand, electrically triggerable primers are expensive. Furthermore, such primers are subject to very strict safety regulations, so that the handling of these is strictly regulated. This makes the development of circuit breakers expensive.

Finally, primers are only produced in small quantities, so that the availability and the price are not satisfactory.

For that reason, the subject matter was based on the object of providing a circuit breaker for power cables which ensures a reliable disconnection but which dispenses with the use of an electrically ignited pyrotechnic primer.

This object is achieved in terms of the subject matter by forming the auxiliary drive from a percussion cap. In contrast to igniters of conventional pyrotechnic primers, percussion caps are considerably smaller in size. Percussion caps are thus preferably between 1 and 5 mm diameter and are between 1 and 5 mm in height. The amount of propelling charge in a percussion cap is hence considerably less than in a pyrotechnic primer. The percussion cap is preferably formed from a container supplied with a pyrotechnic propellant. The container is preferably a cylindrical pot which is open on one side. The propellant is preferably simply held in the cylindrical pot by means of a plastic material. The percussion cap can be ignited by means of a mechanical trigger, wherein, however, here an additional, electric ignition can also be provided. Therefore, a customarily mechanically ignitable percussion cap can also in terms of the subject matter be electrically ignited, by implementing an electric ignition wire in the percussion cap already produced. A helium-tight glass leadthrough, as employed with pyrotechnic primers, can be dispensed with.

According to one advantageous exemplary embodiment, the percussion cap is an ammunition percussion cap. An ammunition percussion cap is the part of the ammunition which is activated by means of the piston. It usually sits centrically at the base of a bullet and is activated by the bolt of a gun. In the present case, electric ignition can be achieved, for example, by heating an ignition wire or by heating the container forming the percussion cap.

According to one advantageous exemplary embodiment, the percussion cap is formed to be mechanically ignited. That means that the percussion cap is initially produced to be mechanically ignited but can also in terms of the subject matter be electrically ignited. The advantage of using an ammunition percussion cap is that it is available in very large quantities and is only subject to minimal safety regulations. The result of this is that these percussion caps are particularly cheaply available.

According to one advantageous exemplary embodiment, i is proposed that the percussion cap is supplied with an electric igniter. The electric igniter can result in the percussion cap, or an ignition wire in the percussion cap, being heated in such a way that the propellant is ignited in the percussion cap.

According to one advantageous exemplary embodiment, it is proposed that the percussion cap is supplied with a solid propellant. The solid propellant can be held in the percussion cap by, for example, a plastic material.

According to one advantageous exemplary embodiment, it is proposed that the percussion cap is part of a cartridge.

A cartridge, in the sense of the subject matter, is a casing filled with pyrotechnic propellants, in which the casing opening is sealed. In gun technology, a cartridge denotes a container which receives a propelling charge of a projectile and seals the loading chamber at the rear. In contrast to a bullet casing, the cartridge, however, does not have a projectile. The term cartridge is to be understood in this sense in terms of the subject matter.

By using a percussion cap, which is available in very large quantities through gun technology, or a cartridge, the circuit breaker can be produced particularly cost-effectively. The ammunition (percussion cap, cartridge) also subject to less strict safety regulations than a pyrotechnic primer.

According to one advantageous exemplary embodiment, it is proposed that the percussion cap has nitrocellulose as the propellant. Nitrocellulose has proved to be a particularly reliable propellant.

According to one advantageous exemplary embodiment, it is proposed that the percussion cap is arranged on the disconnecting element in such a way that the gas pressure arising when the percussion cap is triggered drives the disconnecting element to electrically and/or mechanically disconnect the electrical connection between the terminals. Preferably, the percussion cap is arranged in close proximity to the disconnecting element. Preferably, the disconnecting element and the percussion cap or the cartridge are arranged in a common housing, for example a casing, which is sealed in a gas-tight manner. The percussion cap or the cartridge can also be cast together with the disconnecting element in a housing.

It is also proposed that the cartridge has a crimped casing mouth or a plastic cap for fixing the propellant in the cartridge. The crimped casing mouth or the plastic cap also serves to build up a sufficiently large amount of gas pressure within the cartridge after triggering the propellant. This ensures that the cartridge exerts enough pressure on the disconnecting element to disconnect the terminals from one another.

According to one advantageous exemplary embodiment, the cartridge is a blank cartridge. Blank cartridges are readily commercially available. Blank cartridges are extremely cheap. Blank cartridges are standardised, in particular because they are adapted to the various gun types. Therefore, blank cartridges can be particularly easily used as the auxiliary drive.

Cartridges for handguns can be obtained particularly cheaply, so it is proposed that the cartridge is designed for a handgun. Such cartridges have an explosive power which is high enough to drive the disconnecting element and are nevertheless cheap and easy to obtain. Such cartridges are also calibrated and standardised for the different gun types, so that these are suited for mass use.

According to one advantageous exemplary embodiment, it is proposed that the cartridge has a calibre which is commercially available. Commercially available calibres are, for example, 9, 12, 16, 45 and suchlike. Different calibre designations are known for the various handguns. A commercially available calibre is to be understood to the effect that it is a calibre which can be used for a number of guns and hence cartridges are easy to obtain for it.

According to one advantageous exemplary embodiment, it is proposed that that an ignition device ignites the percussion cap when a trigger condition is present. In this case, just like in gun technology, this can be mechanically triggered. Here, a piston can be mechanically accelerated in the direction of the base of the percussion cap or the cartridge base, so that it presses into the base of the percussion cap or the cartridge base. The forces arising here are sufficient to ignite the propellant in the percussion cap or the cartridge.

For that reason, according to one advantageous exemplary embodiment, it is proposed that the ignition device is a mechanically driven piston. Here, for example, a piston can be pre-tensioned by means of a spring. The piston can be released from a fixed position, for example by means of an electric impulse which triggers an electric magnet, so that the spring force is exerted on the piston and the piston is accelerated in the direction of the cartridge base.

The subject matter is explained in more detail below with the aid of a drawing showing an exemplary embodiment. In the drawing:

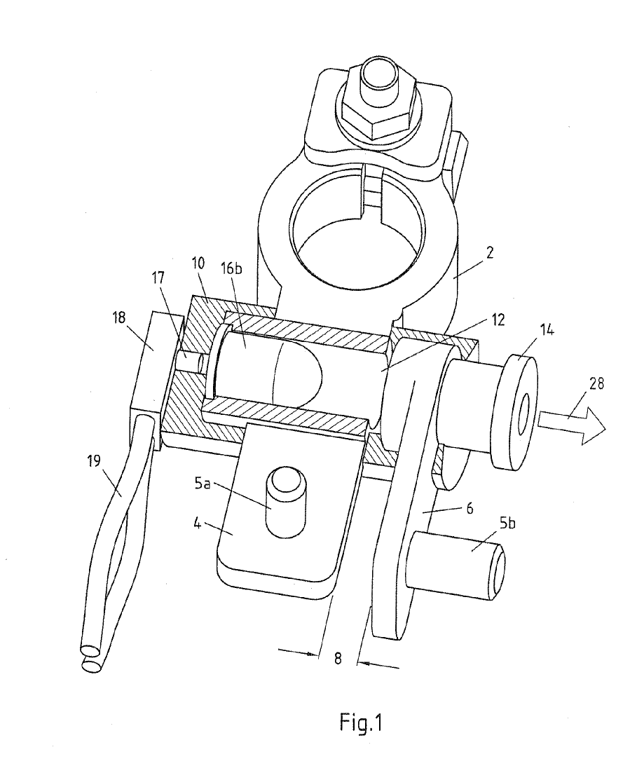

FIG. 1 shows a first view of a circuit breaker with a cartridge;

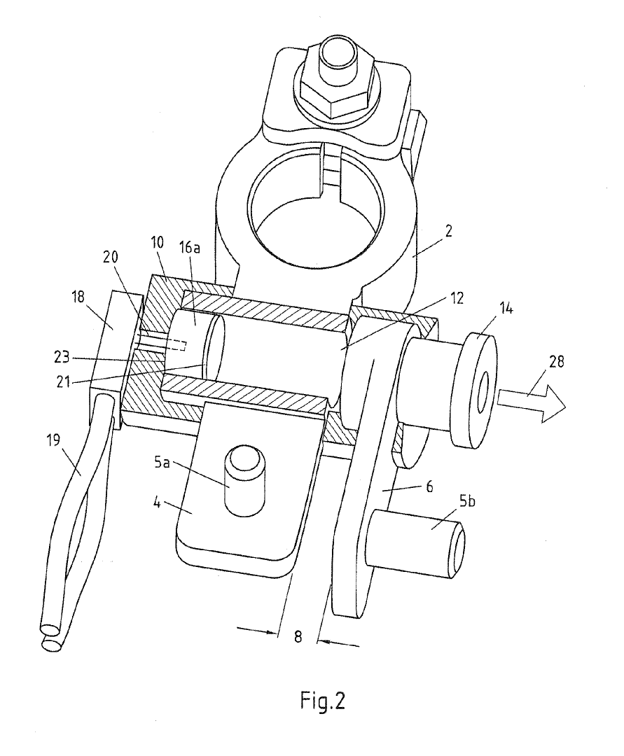

FIG. 2 shows a second view of a circuit breaker with a percussion cap.

FIG. 1 shows a circuit breaker, having a pole shoe 2. This pole shoe 2 serves to connect the circuit breaker to a battery terminal of an automotive battery, in particular the positive pole. A first terminal 4 is arranged on the pole shoe 2. A second terminal 6 is also illustrated. The first terminal 4 is electrically insulated from the second terminal 6 by the air gap 8. It can be seen that the terminals 4 and 6 have concentric cylinders, into which a press-in bolt 14 can be inserted as the contact pin, as is still to be shown below.

The circuit breaker has an additional plastic overmould 10. The plastic overmould 10 surrounds the concentric cylinders of the terminals 4 and 6. The air gap 8 between the terminals 4 and 6 is further insulated by the plastic overmould 10. The plastic overmould 10 also secures the positions of the terminals 4 and 6 in relation to one another. These are fixed in relation to one another by means of the plastic overmould 10 and hence they cannot move any more relative to one another.

Additionally, a bore 12 is shown which goes through the plastic case 10, the terminal 6 and the terminal 4. The bore 12 is such that it is a through bore through the terminal 6 and a through bore in the terminal 4. In the end of the bore 12 facing away from the terminal 6 in the terminal 4 the bore 12 has a circumferential recess. The recess serves to receive a collar of a cartridge 16, so that the cartridge 16 can only be inserted into the bore 12 up to the point where the collar comes into contact with the recess. Afterwards, the case 10 can be applied.

By means of the bore 12, a hollow space is formed in the terminal 4 for receiving the cartridge 16. A press-in bolt 14 can be inserted into the bore 12, as is still to be shown below.

In addition to the bore 12, the circuit breaker has pins 5. These pins 5 enable battery cables to be connected to the circuit breaker. The terminal 6 is electrically insulated from the pole shoe 2 by the insulation between the terminals 4 and 6. Cables which are connected to pin 5b are hence not in the current path of the battery terminal. Pin 5a is provided to guarantee emergency power supplies and to be able to supply, for example, uncritical areas with power even after the circuit breaker has been triggered. This pin enables jump leads to be connected which can supply uncritical areas with power.

In addition, a press-in bolt 14 is shown which can be inserted into the bore 12. In the inserted state, the press-in bolt 14 establishes an electrical contact between terminal 4 and terminal 6. In the shot state, i.e. in the pressed-out state, the electrical contact between the terminal 4 and the terminal 6 is disconnected. The press-in bolt 14 can therefore be understood as a disconnecting element.

However, a disconnecting element can also, for example, be a bolt or a cutting blade which is accelerated by means of the gas pressure in the cartridge 16 and disrupts a current path between the terminals.

The cartridge 16 is inserted into the hollow space of the bore 12. In the figure, the plastic case 10 is sliced open, so that the arrangement of the cartridge 16 in the bore 12 can be seen. As can be seen, the bore 12 is adapted to the outer circumference of the cartridge 16 and the cartridge 16 is firmly arranged in the bore 12. It can be seen that the cartridge is arranged with its base on the base of the bore 12. A shoot bolt 17 can be accelerated through the base of the bore 12 and through the case 10 respectively. For this purpose, the case 10 has an opening in the area of the cartridge base. The shoot bolt 17 is accelerated by the actuating device 18. If the shoot bolt 17 is accelerated then it strikes the base of the cartridge 16 with a high kinetic energy and deforms it in such a way that the propellant located in the cartridge ignites.

Therefore, in terms of the subject matter, the circuit breaker is activated by a mechanically triggered cartridge. Electric activation is not necessary. Mechanical activation can take place by means of a bolt at the base of the cartridge.

As soon as the shoot bolt 17 strikes the base of the cartridge 16, the cartridge ignites and a high gas pressure forms inside the bore 12. The press-in bolt 14 is shot out of the bore 12 in the direction of the arrow 28 as a result of this gas pressure.

In the figure, the circuit breaker is illustrated in the shot state. A partial section through the plastic case 10 is shown, as already mentioned, so that the attachment of the cartridge 16 and the arrangement of the shoot bolt 17 can be identified better. The shoot bolt 17 is actuated via an actuating device 18. By way of example, the shoot bolt 17 can be coupled to the actuating device 18 by means of a pre-tensioned spring. If the actuating device 18 receives, for example in the event of a crash, a trigger impulse via the connection cables 19, then, for example, an electromagnet can be activated which breaks the attachment of the shoot bolt 17 to the actuating device 18, whereupon the tension spring relaxes and the shoot bolt 17 is accelerated with a high kinetic energy against the base of the cartridge 16.

The ignition of the cartridge 16 causes a rapid expansion of gases in the hollow space of the bore 12, so that the press-in bolt 14 is shot out of the bore 12 in the shoot out direction 28. The terminals 4 and 6 are hereby disconnected from one another.

It can be seen that the press-in bolt 14 has a circumferential annular shoulder, so that it can only be inserted up to a certain depth into the bore 12. This prevents the press-in bolt 14 from being pressed against the cartridge 14 and damaging it or triggering it by mistake.

FIG. 2 also shows a circuit breaker. In contrast to the circuit breaker according to FIG. 1, in the circuit breaker according to FIG. 2 a percussion cap 16a is provided instead of a cartridge 16b. The percussion cap 16a is arranged with its base 23 on the base of the bore 12. The base 23 of the percussion cap 16 is penetrated by an ignition wire 20. The ignition wire 20 is actuated via the actuating device 18. It can be seen that the metallic base 23 of the percussion cap 16a faces away from the press-in bolt 14 and its sealing 21 faces the press-in bolt 14. The sealing 21 is preferably a plastic coating of the container of the percussion cap 16a.

In the event of a trigger, the actuating device 18 actuates the ignition wire 20 in such a way that a current flows via the ignition wire 20. This current causes the ignition wire 20 to heat up and solid propellant in the percussion cap 16a to ignite. The arising gas pressure is discharged in the direction of the sealing 21, so that the press-in bolt 14 is pressed out of the bore 12.

By using the cartridge 16 shown, the circuit breaker can be produced in a particularly simple and cost-effective way. The cartridge 16 is preferably a blank cartridge which is available as a mass-produced article.

1-11. (canceled)

12. Circuit breaker for a power cable, in particular a battery cable of a motor vehicle, comprising:
a first terminal;
a second terminal electrically connected to the first terminal and having a disconnecting element for electrically disconnecting the electrical connection between the terminals, wherein the disconnecting element has an auxiliary drive formed of at least one percussion cap, and the auxiliary drive drives the disconnecting element in the event of a trigger to disconnect the electrical connection between the terminals, wherein the percussion cap is an ammunition percussion cap that is formed to be mechanically ignited and that is additionally supplied with an electric igniter, wherein the electric igniter heats the percussion cap or an ignition wire in the percussion cap in such a way, that the propellant is ignited in the percussion cap.

13. Circuit breaker of claim 12, wherein the percussion cap is supplied with a solid propellant.

14. Circuit breaker of claim 12, wherein the percussion cap is part of a cartridge.

15. Circuit breaker of claim 12, wherein the percussion cap has nitrocellulose as the propellant.

16. Circuit breaker of claim 12, wherein the percussion cap is arranged on the disconnecting element in such a way that the gas pressure arising when the percussion cap is triggered drives the disconnecting element to electrically disconnect the electrical connection between the terminals.

17. Circuit breaker of claim 14, wherein the cartridge has a crimped casing mouth or a plastic cap for fixing the propellant in the cartridge.

18. Circuit breaker of claim 14, wherein the cartridge is a blank cartridge.

19. Circuit breaker of claim 14, wherein the cartridge is designed for a handgun.

20. Circuit breaker of claim 14, wherein the cartridge has a calibre which is commercially available.

21. Circuit breaker of claim 12, wherein an ignition device ignites the percussion cap when a trigger condition is present.

22. Use of an ammunition percussion cap as an auxiliary drive of a circuit breaker of claim 12.
